(19) United States
(12) Patent Application Publication
(10) Pub. No.: US 2012/0148920 A1
(43) Pub. Date: Jun. 14, 2012

(54) POSITIVE ACTIVE MATERIAL FOR LITHIUM BATTERIES AND LITHIUM BATTERY INCLUDING THE SAME

(75) Inventors: Jay-Hyok Song, Yongin-si (KR); Young-Hun Lee, Yongin-si (KR); Yu-Mi Song, Yongin-si (KR); Young-Ki Kim, Yongin-si (KR); Soon-Rewl Lee, Yongin-si (KR); Ick-Kyu Choi, Yongin-si (KR); Yoon-Chang Kim, Yongin-si (KR)

(73) Assignee: Samsung SDI Co., Ltd., Yongin-si (KR)

(21) Appl. No.: 13/237,867

(22) Filed: Sep. 20, 2011

(30) Foreign Application Priority Data
Dec. 14, 2010 (KR) 10-2010-0127853

(51) Int. Cl. H01M 4/525

(52) U.S. Cl. 429/221; 252/182.1

(57) ABSTRACT

A positive active material for lithium batteries, the positive active material comprising a lithium-nickel-iron oxide, and a lithium battery including the positive active material. The lithium-nickel-iron oxide is represented by Formula 1: Li₂Ni₁₋ₓFeₓO₂, wherein about 0<x<about 0.2.

### RELATED APPLICATIONS

This application claims the benefit of Korean Patent Application No. 10-2010-0127853, filed on Dec. 14, 2010, in the Korean Intellectual Property Office, the entire contents of which are incorporated herein by reference.

### BACKGROUND

1. Field

Embodiments of the present invention relate to a positive active material for lithium batteries and a lithium battery including the positive active material.

2. Description of the Related Technology

Recently, lithium batteries have drawn significant attention as power sources for small portable electronic devices. Lithium batteries using organic electrolytes typically have a discharge voltage about twice as high as those using an aqueous alkali electrolyte, and have a higher energy density.

Lithium batteries include negative and positive electrodes, each electrode including an active material that allows intercalation and deintercalation of lithium ions, and an organic electrolyte or a polymer electrolyte filling the gap between the negative and positive electrodes. Lithium batteries produce electrical energy from redox reactions that take place as lithium ions are intercalated into or deintercalated from the positive and negative electrodes.

Currently, lithium batteries typically use carbonaceous materials as a negative active material. However, demand for higher capacity lithium second batteries requires use of high-capacity electrode active materials. To satisfy this requirement, a material such as metal silicon or tin (Sn) that has a charge/discharge capacity higher than that of carbonaceous materials and that are electrochemically alloyable with lithium have typically been used as negative active materials.

However, in some negative active materials, for example, silicon oxide-based materials, the intercalation and deintercalation of lithium ions during charging and discharging are irreversible. Lithium ions intercalated during primary charging are not fully released during a subsequent discharging process. Consequently, some of the positive material used in the first charging process is unable to take part in subsequent charging and discharging cycles.

In order to address these problems, the addition of lithium-rich, high-capacity positive materials has been suggested. However, this approach has failed in terms of achieving satisfactory battery efficiency, and thus further improvement in this regard is still desired.

### SUMMARY

One or more embodiments of the present invention include a positive active material for lithium batteries with improved cell voltage characteristics, and a lithium battery including the positive active material.

Additional aspects will be set forth in part in the description which follows and, in part, will be apparent from the description, or may be learned by practice of the presented embodiments.

According to one or more embodiments of the present invention, a positive active material for lithium batteries includes a lithium-nickel-iron oxide represented by Formula 1 below:

Li₂Ni₁₋ₓFeₓO₂ Formula 1:

wherein, in Formula 1 above, about 0.0<x<about 0.2.

According to one or more embodiments of the present invention, a lithium battery includes a positive electrode, a negative electrode, and a separator between the positive electrode and the negative electrode, wherein the positive electrode includes the positive active material of Formula 1 above.

### BRIEF DESCRIPTION OF THE DRAWINGS

These and/or other aspects will become apparent and more readily appreciated from the following description of the embodiments, taken in conjunction with the accompanying drawings of which:

FIG. 1 is an exploded perspective view of a secondary lithium battery according to an embodiment of the present disclosure;

FIG. 2 is a graph of voltage with respect to charge capacity in lithium secondary batteries manufactured according to Examples 1-3 and Comparative Example 1; and

FIG. 3 is a graph illustrating the results of X-ray diffraction analysis on Li₂Ni_{0.975}Fe_{0.025}O₂ and Li₂Ni_{0.95}Fe_{0.05}O₂ prepared in respective Synthesis Examples 1 and 2, and on Li₂NiO₂.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, in reference to the figures, to explain aspects of the present description.

According to an embodiment of the present invention, there is provided a positive active material for lithium batteries that includes a lithium-nickel-iron oxide represented by Formula 1 below.

Li₂Ni₁₋ₓFeₓO₂ Formula 1

wherein, about 0<x<about 0.2.

In Formula 1, x may be from about 0.01 to about 0.05.

The positive active material of Formula 1 does not generate gas at a battery operating voltage of 4.2V or less, for example, from about 3.5V to about 4.2V, unlike Li₂NiO₂. This ensures structural stability in a battery and may compensate for irreversible lithium intercalation in silicon-based negative electrodes.

The positive active material of Formula 1 may have a high capacity of 250 mAh/g or greater, and in some embodiments, may have a capacity of from about 250 mAh/g to about 400 mAh/g.

Examples of the positive active material include Li₂Ni_{0.975}Fe_{0.025}O₂, Li₂Ni_{0.95}Fe_{0.05}O₂, and LiNi_{0.925}Fe_{0.075}O₂.

The positive active material for lithium batteries may include only the lithium-nickel-iron oxide of Formula 1 above. In some embodiments, the positive active material for lithium batteries may include a mixture of the lithium-nickel-iron oxide of Formula 1 above and at least one lithium-transition metal oxide.

The lithium-transition metal oxide may include at least one material selected from the group consisting of LiCoO₂, LiNiO₂, LiMnO₂, LiMn₂O₄, Li(NiₐCO_{b}Mn_{c})O₂ (wherein 0<a<1, 0<b<1, 0<c<1, and a+b+c=1), LiNi_{1-Y}CO_{Y}O₂, LiCO_{1-Y}Mn_{Y}O₂, LiNi_{1-Y}Mn_{Y}O₂ (wherein 0≦Y<1), Li(NiₐCO_{b}Mn_{c})O₄ (wherein 0<a<2, 0<b<2, 0<c<2, and a+b+c=2), LiMn_{2-z}Ni_{z}O₄, LiMn_{2-z}Co_{z}O₄ (wherein 0<Z<2), LiCoPO₄, and LiFePO₄.

The lithium-nickel-iron oxide of Formula 1 may be from about 0.1 parts to about 20 parts by weight, and in some embodiments, may be from about 8 parts to about 12 parts by weight, based on 100 parts by weight of the lithium-transition metal oxide.

When the amount of the lithium-nickel-iron oxide is within these ranges, generation of gas may be effectively suppressed during repeated charge/discharge cycles.

In the lithium-nickel-iron oxide of Formula 1, a main first peak of Bragg's 2θ angle with respect to a CuK-α X-ray wavelength of 1.541 Å may appear at about 25 degrees and about 29 degrees. Also, a main second peak of Bragg's 2θ angle with respect to the CuK-α X-ray wavelength of 1.541 Å may appear at about 17 degrees to about 22 degrees.

However, the intensity of the first peak at between about 25 degrees and about 29 degrees may be about 5 times or more, and in some embodiments may be about 5 times to about 80 times or more, greater than the intensity of the second peak at about 17 degrees and about 22 degrees.

Based on the results of X-ray diffraction (XRD) analysis on Li₂NiO₂ under the same conditions as described above, the intensity of the peak at about 25 degrees to about 29 degrees is about 4.9 times or less, for example, about 4.8 times or less, greater than that at about 17 degrees and about 22 degrees.

The lithium-nickel-iron oxide of Formula 1 may have an average particle diameter of about 1 microns to about 30 microns, and in some embodiments, may have an average particle diameter of about 3 microns to about 7 microns.

When the average particle diameter of the lithium-nickel-iron oxide is within these ranges, good capacity characteristics may be obtained.

A method of preparing the lithium-nickel-iron oxide of Formula 1 will now be described.

A lithium oxide, a nickel oxide, and an iron precursor may be mixed together to obtain a mixture, which is then thermally treated.

The lithium oxide may include Li₂O, and the nickel oxide may include NiO.

The iron precursor may include FeC₂O₄.

The nickel oxide may be from about 0.4 moles to about 0.6 moles based on 1 mole of the lithium oxide. The iron precursor may be from about 0.0001 moles to about 0.1 moles based on 1 mole of the lithium oxide.

When the amounts of the nickel oxide and iron precursor are within these respective ranges, the lithium-nickel-iron oxide of Formula 1 above may effectively suppress gas from being generated during charging and discharging.

In some embodiments, the thermal treatment may be performed using a solid phase reaction method. The thermal treatment temperature may be from about 500° C. to about 700° C. When the thermal treatment temperature is within this range, a final positive active material may have good capacity characteristics.

The thermal treatment time varies depending on the thermal treatment temperature. In some embodiments the thermal treatment time may be from about 5 hours to about 24 hours.

The thermal treatment may be performed in an inert gas atmosphere. Suitable examples of an inert gas include nitrogen, argon, and the like.

The resulting product of the above processes may be grinded to an average particle diameter of about 3 μm to about 7 μm, thereby preparing the positive active material for lithium batteries.

Hereinafter, a method of manufacturing a lithium battery using the positive active material described above will be described, wherein the lithium battery includes a positive electrode, a negative electrode, an electrolyte, and a separator.

The positive electrode and the negative electrode are fabricated by respectively coating a positive active material layer composition and a negative active material layer composition on current collectors and drying the resulting products.

The lithium-nickel-iron oxide of Formula 1 that is used as a positive active material, a conducting agent, and a solvent may be mixed to obtain a composition for forming a positive active material layer.

The lithium-nickel-iron oxide of Formula 1, and a lithium-transition metal oxide, which is commonly used as a positive active material for lithium batteries, may be used together.

The binder can facilitate binding between the positive active material and the conducting agent, and binding of the positive active material to the current collector. The amount of binder may be from about 1 part to about 50 parts by weight, and in some embodiments, may be from about 10 parts to about 15 parts by weight, based on 100 parts by weight of the total weight of the positive active material. When the amount of binder is within these ranges, the positive active material layer may bind strongly to the current collector.

Examples of the binder include polyvinylidene fluoride (PVDF), polyvinyl alcohols, carboxymethylcellulose (CMC), starch, hydroxypropylcellulose, regenerated cellulose, polyvinylpyrollidone, tetrafluoroethylene, polyethylene, polypropylene, ethylene-propylene-diene terpolymer (EPDM), sulfonated EPDM, styrene butadiene rubber, fluoro rubber, and various copolymers.

The conducting agent is not particularly limited, and may be any material as long as it has a suitable conductivity without causing chemical changes in the fabricated battery. Examples of the conducting agent include graphite, such as natural or artificial graphite; carbon blacks such as acetylene black, ketjen black, channel black, furnace black, lamp black, and thermal black; conductive fibers, such as carbon fibers and metallic fibers; metallic powders, such as carbon fluoride powder, aluminum powder, and nickel powder; conductive whiskers such as zinc oxide and potassium titanate; conductive metal oxides such as titanium oxide; and polyphenylene derivatives. The binder may be from about 2 parts to about 30 parts by weight, and in some embodiments, may be from about 10 parts to about 15 parts by weight, based on 100 parts by weight of the total weight of the positive active material. When the amount of the conducting agent is within these ranges, the positive electrode may have good conductive characteristics and maintain capacity characteristics.

The solvent may include N-methyl-2-pyrrolidone. The solvent may be from about 100 parts to about 400 parts by weight based on 100 parts by weight of the positive active material. When the amount of the solvent is within these ranges, a process for forming the positive active material layer may be facilitated.

A positive electrode current collector is fabricated to have a thickness of about 3 μm to about 500 μm, and may be any current collector as long as it has high conductivity without causing chemical changes in the fabricated battery. Examples of the positive electrode current collector include stainless steel, aluminum, nickel, titanium, sintered carbon, and aluminum or stainless steel that is surface-treated with carbon, nickel, titanium, or silver. The positive electrode current collector may be processed to have fine irregularities on surfaces thereof so as to enhance the adhesive strength of the current collector to the positive active material. The positive electrode current collector may be in any of various forms including that of a film, a sheet, a foil, a net, a porous structure, foam, and non-woven fabric.

Apart from the positive active material layer composition prepared above, a negative active material, a binder, a conducting agent, and a solvent may be mixed together to prepare a composition for forming a negative active material layer.

Examples of the negative active material include materials allowing intercalation and deintercalation of lithium ions, such as graphite, carbon, lithium metal, lithium alloys, and silicon oxide-based materials.

The binder facilitates binding between the negative active material and the conducting agent, and binding of the negative active material to the current collector. The binder may be from about 1 part to about 50 parts by weight, and in some embodiments, may be from about 10 parts to about 15 parts by weight, based on 100 parts by weight of the total weight of the negative active material. A binder that is the same as that used in the positive electrode may be used.

The conducting agent may be from about 2 parts to about 30 parts by weight, and in some embodiments, may be from about 10 parts to about 15 parts by weight, based on 100 parts by weight of the total weight of the negative active material. When the amount of the conducting agent is within these ranges, the negative electrode may have good conductive characteristics.

The solvent may be from about 80 parts to about 400 parts by weight based on 100 parts by weight of the negative active material. When the amount of the solvent is within this range, a process for forming the negative active material layer may be facilitated.

The same kinds of conducting agents and solvents as those used in the positive electrode may be used.

The negative current collector is fabricated to have a thickness of about 3 μm to about 500 μm. The negative current collector is not particularly limited, and may be any material as long as it has a suitable conductivity without causing chemical changes in the fabricated battery. Examples of the negative current collector include copper, stainless steel, aluminum, nickel, titanium, sintered carbon, copper or stainless steel that is surface-treated with carbon, nickel, titanium or silver, and aluminum-cadmium alloys. In addition, similar to the positive electrode current collector, the negative electrode current collector may be processed to have fine irregularities on surfaces thereof so as to enhance the adhesive strength of the negative electrode current collector to the negative active material, and may be used in any of various forms including that of a film, a sheet, a foil, a net, a porous structure, foam, and non-woven fabric.

A separator is disposed between the positive and negative electrodes manufactured according to the processes described above.

The separator may be interposed between the positive electrode plate and the negative electrode plate to form a battery assembly. The battery assembly is wound or folded and encased in a spherical battery case or a rectangular battery case, and then an electrolyte solution is supplied into the battery assembly, thereby completing the manufacture of a lithium ion battery. Alternatively, a plurality of electrode assemblies may be stacked in a bi-cell structure and impregnated with an organic electrolyte according to the present invention. The resulting structure is placed into a pouch and sealed, thereby completing the manufacture of a lithium ion polymer battery.

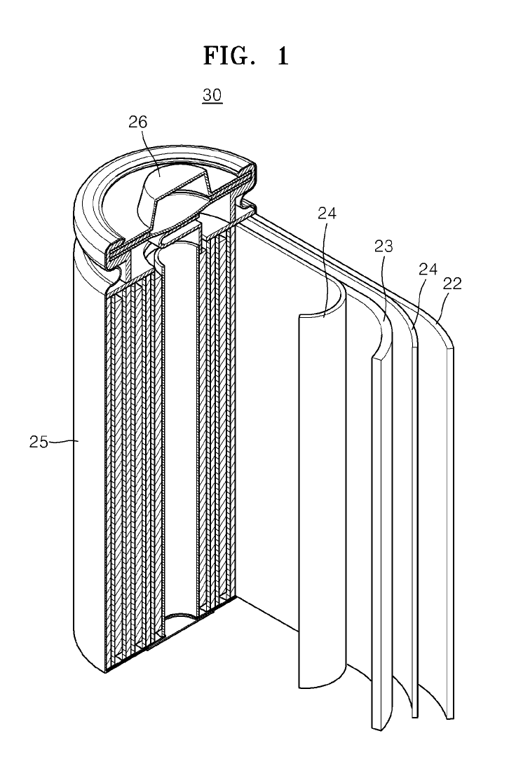

FIG. 1 is a schematic perspective view of a lithium battery 30 according to an embodiment of the present invention. Referring to FIG. 1, the lithium battery 30 includes an electrode assembly having a positive electrode 23 that includes the positive active material according to an embodiment of the present invention, a negative electrode 22, and a separator 24 between the positive electrode 23 and the negative electrode 22. The electrode assembly is contained within a battery case 25, and a sealing member 26 seals the battery case 25. An electrolyte solution (not shown) is injected into the battery case 25 to impregnate the electrolyte assembly. The lithium battery 30 is manufactured by sequentially stacking the positive electrode 23, the negative electrode 22, and the separator 24 on one another to form a stack, rolling the stack into a spiral form, and inserting the rolled up stack into the battery case 25.

The separator 24 may have a pore diameter of about 0.01 μm to about 10 μm and a thickness of about 5 μm to about 300 μm. Examples of the separator 24 include olefin-based polymers, such as polyethylene, polypropylene, and the like, and glass fibers, each of which may be in a sheet form or non-woven fabric form. These separators may be used along with a polymer electrolyte.

The electrolyte solution may include a non-aqueous organic solvent and a lithium salt.

The non-aqueous organic solvent may include a chain carbonate and a cyclic carbonate.

Examples of the chain carbonate include dimethyl carbonate (DMC), ethylmethyl carbonate (EMC), diethyl carbonate (DEC), methylpropyl carbonate (MPC), dipropyl carbonate (DPC), ethylpropyl carbonate (EPC), ethylmethyl carbonate (EMC), and the like.

Examples of the cyclic carbonate include ethylene carbonate (EC), propylene carbonate (PC), and the like.

The total amount of the chain carbonate may be from about 50 parts to about 90 parts by volume based on 100 parts by volume of the non-aqueous organic solvent.

The non-aqueous organic solvent may further include at least one material selected from the group consisting of an ester-based solvent, an ether-based solvent, a ketone-based solvent, an alcohol-based solvent, and an aprotic solvent.

Examples of the ester-based solvent include methyl acetate, ethyl acetate, n-propyl acetate, dimethyl acetate, methyl propionate, ethyl propionate, γ-butyrolactone, decanolide, valerolactone, mevalonolactone, caprolactone, and the like. However, any suitable ester-based solvent may be used.

Examples of the ether-based solvent include dibutyl ether, tetraglyme, diglyme, dimethoxy ethane, 2-methyltetrahydrofuran, and tetrahydrofuran. However, any suitable ether-based solvent may be used.

An example of the ketone-based solvent is cyclohexanone. However, any suitable ketone-based solvent may be used.

Examples of the alcohol-based solvent include ethyl alcohol and isopropyl alcohol. However, any suitable alcohol-based solvent may be used.

Examples of the aprotic solvent include nitriles (such as R—CN, wherein R is a C₂-C₂₀ linear, branched, or cyclic hydrocarbon-based moiety that may include an double-bonded aromatic ring or an ether bond), amides (such as dimethylformamide), dioxolanes (such as 1,3-dioxolane), and sulfolanes. However, any suitable aprotic solvent may be used.

Examples of the non-aqueous organic solvent include ethylene carbonate (EC), ethylmethyl carbonate (EMC) and dimethyl carbonate (DMC). For example, the non-aqueous organic solvent may be a mixture of ethylene carbonate (EC), ethylmethyl carbonate (EMC) and dimethyl carbonate (DMC) in a volume ratio of 1:1:1, but is not limited thereto.

The lithium salt in the electrolyte may be dissolved in the non-aqueous organic solvent and may function as a source of lithium ions to enable the basic operation of the lithium battery, and can accelerate the migration of lithium ions between the positive electrode and the negative electrode.

For example, the lithium salt may include at least one supporting electrolyte salt selected from the group consisting of LiPF₆, LiBF₄, LiSbF₆, LiAsF₆, LiN (SO₂C₂F₅)₂, Li(CF₃SO₂)₂N, LiC₄F₉SO₃, LiClO₄, LiAlO₂, LiAlCl₄, LiN (CₓF₂ₓ₊₁SO₂)(C_{y}F_{2y+1}F₁SO₂) (where x and y are each independently a natural number), LiCl, LiI, and LiB (C₂O₄)₂ (lithium bis(oxalato) borate or LiBOB). Combinations of lithium salts may be used.

The concentration of the lithium salt may be from about 0.1M to about 2.0M, and in some embodiments, may be from about 0.6M to about 2.0M. In some other embodiments, the concentration of the lithium salt may be from about 0.7M to about 1.0M. When the concentration of the lithium salt is within these ranges, the electrolyte may have appropriate conductivity and viscosity, and thus lithium ions may efficiently migrate.

Embodiments of the invention will be further described in greater detail with reference to the following examples. These examples are presented for illustrative purposes only and do not limit the scope of the inventive concept.

### Synthesis Example 1

### Preparation of Li₂Ni_{0.975}Fe_{0.025}O₂

Li₂O, NiO, and FeC₂O₄.2H₂O were mixed in a stoichiometric molar ratio of 2:0.975:0.025 by a mechanical mixer to obtain a mixture.

Then, in order to suppress generation of LiNiO₂ phase in an active material, the resulting mixture was sintered in an inert gas (N₂) atmosphere at about 550° C. for about 10 hours to prepare Li₂Ni_{0.095}Fe_{0.025}O₂. The rates in temperature increase and cooling were fixed to 2° C. per minute.

### Synthesis Example 2

### Preparation of Li₂Ni_{0.95}Fe_{0.05}O₂

Li₂Ni_{0.950}Fe_{0.05}O₂ was prepared in the same manner as in Synthesis Example 1, except that the molar ratio of Li₂O, NiO, and FeC₂O₄.2H₂O was varied to 2:0.95:0.05.

### Synthesis Example 3

### Preparation of Li₂Ni_{0.925}Fe_{0.075}O₂

Li₂Ni_{0.925}Fe_{0.075}O₂ was prepared in the same manner as in Synthesis Example 1, except that the molar ratio of Li₂O, NiO, and FeC₂O₄.2H₂O was varied to 2:0.925:0.075.

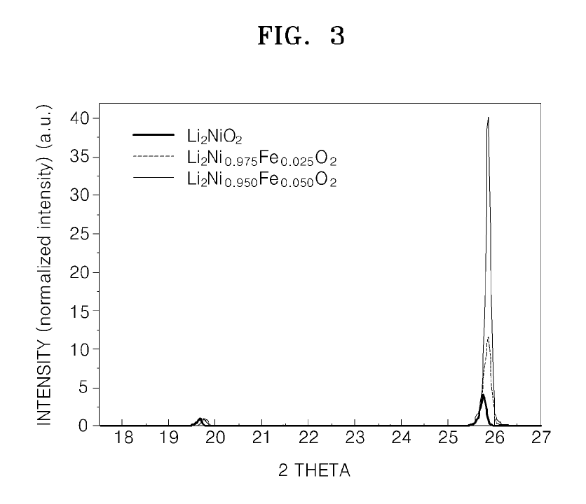

X-ray diffraction (XRD) analysis was performed on the Li₂Ni_{0.975}Fe_{0.025}O₂ and Li₂Ni_{0.95}Fe_{0.05}O₂ prepared in respective Synthesis Examples 1 and 2, and on Li₂NiO₂. The results are shown in FIG. 3. The XRD analysis was performed using an X-ray spectrometer (available from PANalytical) at a scanning region from about 15 degrees to about 70 degrees, a scan interval of about 0.05 degrees, and a scan rate of one time per 0.5 sec.

Referring to FIG. 3, in the Li₂Ni_{0.975}Fe_{0.025}O₂ and Li₂Ni_{0.95}Fe_{0.05}O₂ prepared according to respective Synthesis Examples 1 and 2, main peaks appearing at between 25 degrees and 29 degrees have greater intensities than a main peak of the Li₂NiO₂. When the intensities of the peaks appearing between 17 degrees and 22 degrees are normalized to an intensity of 1, the main peaks of the Li₂Ni_{0.975}Fe_{0.025}O₂ and Li₂Ni_{0.95}Fe_{0.05}O₂ at about 25 degrees to about 29 degrees have intensities of 5 times or more greater than the peaks at between those of between 17 degrees and 22 degrees with an increasing amount of Fe.

### Example 1

### Manufacture of Positive Electrode and Lithium Secondary Battery Including the Positive Electrode

The positive active material Li₂Ni_{0.975}Fe_{0.025}O₂ prepared according to Synthesis Example 1, polyvinylidene fluoride (PVDF), and carbon were dispersed in a weight ratio of 90:5:5 in N-methylpyrrolidone to prepare a positive electrode slurry.

The positive electrode slurry was coated on an aluminum (Al)-foil to form a thin positive electrode plate having a thickness of 60 μm, which was then dried at about 135° C. for about 3 hours or longer, and then pressed to manufacture a positive electrode.

Apart from the positive electrode, a lithium metal was used as a negative electrode. 1.3M of LiPF₆ was added to a solvent prepared by mixing ethylene carbonate (EC), ethylmethyl carbonate (EMC), and dimethyl carbonate (DMC) in a volume ratio of 1:1:1, to prepare an electrolyte solution.

The positive electrode and the negative electrode with a porous polyethylene (PE) film separator therebetween were assembled to form a battery assembly, which was then rolled up, pressed and placed into a battery case. Then, the electrolyte solution was injected into the battery case to manufacture a positive half cell.

### Example 2

### Manufacture of Positive Electrode and Lithium Secondary Battery Including the Positive Electrode

A lithium secondary battery was manufactured in the same manner as in Example 1, except that the Li₂Ni_{0.95}Fe_{0.05}O₂ of Synthesis Example 2, instead of the Li₂Ni_{0.975}Fe_{0.025}O₂ of Synthesis Example 1, was used to manufacture a positive electrode.

### Example 3

### Manufacture of Positive Electrode and Lithium Secondary Battery Including the Positive Electrode

A lithium secondary battery was manufactured in the same manner as in Example 1, except that the Li₂Ni_{0.925}Fe_{0.075}O₂ of Synthesis Example 3, instead of the Li₂Ni_{0.975}Fe_{0.025}O₂ of Synthesis Example 1, was used to manufacture a positive electrode.

### Comparative Example 1

### Manufacture of Positive Electrode and Lithium Secondary Battery Including the Positive Electrode

A lithium secondary battery was manufactured in the same manner as in Example 1, except that Li₂NiO₂ was used as a positive active material.

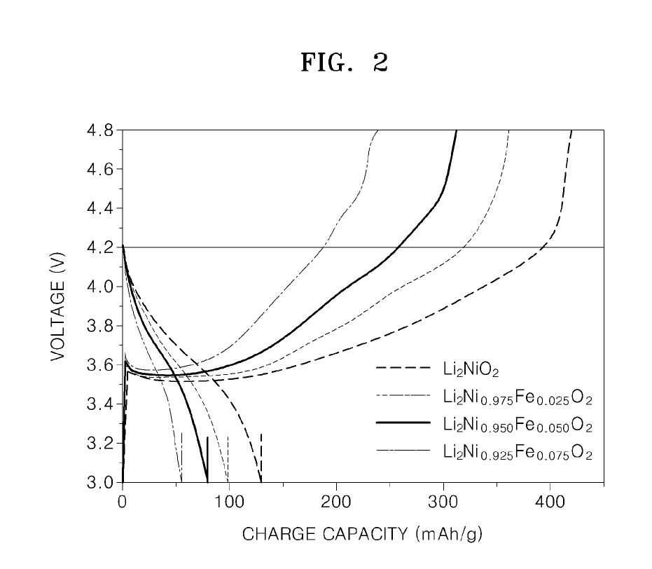

In the lithium secondary batteries of Examples 1 to 3 and Comparative Example 1 voltage characteristics with respect to charge capacity were measured. The results are shown in FIG. 2.

Charge capacity characteristics were measured at room temperature in a 0.1 C constant current mode. In addition, a measurement voltage range was extended beyond 4.2V to 4.8V to observe gas emission characteristics.

Referring to FIG. 2, in the lithium secondary battery of Comparative Example 1, O₂ gas was generated at about 4.2V due to the Li₂NiO₂, and a change in slope of the voltage-capacity plot is shown.

However, in the lithium secondary batteries of Examples 1 to 3, Li diffusion coefficients were reduced due to the structural change in Li₂NiO₂ caused by the substitution of Fe, which increased the slopes of the voltage-capacity plots during charging. Accordingly, O₂ gas was generated at a higher voltage, leading to a slope increase in the voltage-capacity plots of Examples 1 to 3, as compared to the voltage-capacity plot of Comparative Example 1.

Based on these results, the generation of O₂ gas may be controlled, using the positive active materials of Synthesis Examples 1-3, to occur at a voltage equal to or greater than a common battery charge voltage of 4.2V.

Gas generation characteristics of the lithium secondary batteries of Examples 1-3 and Comparative Example 1 were measured. The results are shown in Table 1 below.

The amount of generated gas in Table 1 was measured as follows.

A positive electrode plate was cut to a size of 20 mm×5 mm and then sealed in a pouch cell, which was then charged at a 0.1 C rate to 4.2V. After completion of the charging, the generated gas was collected using a roller and quantified.

TABLE 1

| | | | Amount of | Amount of |
|---|---|---|---|---|
| | | Amount of | generated | generated gas |
| | Capacity | generated | gas per | per capacity |
| Example | (mAh/g) | gas (cc) | weight (cc/g) | (mAh/g) |
| Comparative | 395 | 6.8 | 4.7 | 0.017 |
| Example 1 | | | | |
| (Li₂NiO₂) | | | | |
| Example 1 | 318 | Not | — | — |
| (Li₂Ni_{0.975}Fe_{0.025}O₂) | | detectable | | |
| Example 2 | 260 | Not | — | — |
| (Li₂Ni_{0.950}Fe_{0.050}O₂) | | detectable | | |
| Example 3 | 186 | Not | — | — |
| (Li₂Ni_{0.925}Fe_{0.075}O₂) | | detectable | | |

Table 1 shows that gas was not generated in the lithium secondary batteries of Examples 1 to 3 during charging, unlike the lithium secondary battery of Comparative Example 1. This indicates that in the lithium secondary batteries of Examples 1 to 3, the gas generation mechanism of Li₂NiO₂ is effectively suppressed. Although not appearing in XRD peaks, the unreacted Li may be present in the form of Li₅FeO₄, which does not take part in the generation of gas.

As described above, in a positive active material for lithium batteries that is in accordance with the one or more of the above embodiments of the present invention, gas is not generated during repeated charging and discharging. A lithium battery with good capacity and cell voltage characteristics may be manufactured using the positive active material.

It should be understood that the embodiments described herein should be considered in a descriptive sense only and not for purposes of limitation. Descriptions of features or aspects within each embodiment should typically be considered as available for other similar features or aspects in other embodiments.

What is claimed is:

1. A positive active material for a lithium battery, the positive active material comprising a lithium-nickel-iron oxide represented by Formula 1 below:
Li₂Ni₁₋ₓFeₓO₂ Formula 1
wherein about 0<x<about 0.2.

2. The positive active material of claim 1, wherein x is from about 0.01 to about 0.05.

3. The positive active material of claim 1, wherein the lithium-nickel-iron oxide comprises at least one material selected from the group consisting of Li₂Ni_{0.975}Fe_{0.025}O₂, Li₂Ni_{0.95}Fe_{0.05}O₂, and Li₂Ni_{0.925}Fe_{0.075}O₂.

4. The positive active material of claim 1, wherein the lithium-nickel-iron oxide has an XRD spectrum having a first peak at a Bragg's 2θ angle from about 25 degrees to about 29 degrees with respect to a CuK-α X-ray wavelength of 1.541 Å, and a second peak at a Bragg's 2θ angle from about 17 degrees to about 22 degrees with respect to the CuK-α X-ray wavelength of 1.541 Å, wherein the first and second peaks have intensities such that the intensity of the first peak is about 5 times or more greater than the intensity of the second peak.

5. The positive active material of claim 1, further comprising at least one lithium-transition metal oxide selected from the group consisting of LiCoO₂, LiNiO₂, LiMnO₂, LiMn₂O₄, Li(NiₐCO_{b}Mn_{c})O₂ (wherein 0<a<1, 0<b<1, 0<c<1, and a+b+c=1), LiNi_{1-Y}CO_{Y}O₂, LiCO_{1-Y}Mn_{Y}O₂, LiNi_{1-Y}Mn_{Y}O₂ (wherein 0≦Y<1), Li(NiₐCO_{b}Mn_{c})O₄ (wherein 0<a<2, 0<b<2, 0<c<2, a+b+c=2), LiMn_{2-z}Ni_{z}O₄, LiMn_{2-z}Co_{z}O₄ (wherein 0<Z<2), LiCoPO₄, and LiFePO₄.

6. The positive active material of claim 5, wherein the lithium-transition metal oxide is about 0.1 parts to about 20 parts by weight based on 100 parts by weight of the lithium-nickel-iron oxide.

7. A lithium battery comprising a positive electrode, a negative electrode, and a separator between the positive electrode and the negative electrode, wherein the positive electrode comprises the positive active material comprising a lithium-nickel-iron oxide represented by Formula 1 below:
Li₂Ni₁₋ₓFeₓO₂ Formula 1
wherein about 0<x<about 0.2.

8. The lithium battery of claim 7, wherein x is from about 0.01 to about 0.05.

9. The lithium battery of claim 7, wherein the lithium-nickel-iron oxide comprises at least one material selected from the group consisting of Li₂Ni_{0.975}Fe_{0.025}O₂, Li₂Ni_{0.95}Fe_{0.05}O₂, and Li₂Ni_{0.925}Fe_{0.075}O₂.

10. The lithium battery of claim 7, wherein the lithium-nickel-iron oxide has an XRD spectrum having a first peak at a Bragg's 2θ angle from about 25 degrees to about 29 degrees with respect to a CuK-α X-ray wavelength of 1.541 Å, and a second peak at a Bragg's 2θ angle from about 17 degrees to about 22 degrees with respect to the CuK-α X-ray wavelength of 1.541 Å, wherein the first and second peaks have intensities such that the intensity of the first peak is about 5 times or more greater than the intensity of the second peak.

11. The lithium battery of claim 7, wherein the positive electrode further comprises at least one lithium-transition metal oxide selected from the group consisting of LiCoO₂, LiNiO₂, LiMnO₂, LiMn₂O₄, Li(NiₐCO_{b}Mn_{c})O₂ (wherein 0<a<1, 0<b<1, 0<c<1, and a+b+c=1), LiNi_{1-Y}CO_{Y}O₂, LiCO_{1-Y}Mn_{Y}O₂, LiNi_{1-Y}Mn_{Y}O₂ (wherein 0≦Y<1), Li(NiₐCO_{b}Mn_{c})O₄ (wherein 0<a<2, 0<b<2, 0<c<2, a+b+c=2), LiMn_{2-z}Ni_{z}O₄, LiMn_{2-z}Co_{z}O₄ (wherein 0<Z<2), LiCoPO₄, and LiFePO₄.

12. The lithium battery of claim 11, wherein the lithium-transition metal oxide is about 0.1 parts to about 20 parts by weight based on 100 parts by weight of the lithium-nickel-iron oxide.
